(19) United States
(12) Patent Application Publication
(10) Pub. No.: US 2013/0192336 A1
(43) Pub. Date: Aug. 1, 2013

(54) PROTECTIVE DEVICE

(71) Applicant: Sean James O'Connor, Tauranga (NZ)

(72) Inventor: Sean James O'Connor, Tauranga (NZ)

(73) Assignee: Delloch Limited, Tauranga (NZ)

(21) Appl. No.: 13/878,166

(22) PCT Filed: Oct. 6, 2010
(86) PCT No.: PCT/NZ2010/000197

§ 371 Date: Apr. 5, 2013

(51) Int. Cl. G01N 3/30

(52) U.S. Cl. CPC G01N 3/30
USPC 73/12.01

(57) ABSTRACT

There is provided a protective device, and in particular a device to assist in minimising injury to a person's hips caused by a fall. The device includes a plurality of guards, and a securing portion to hold the guards in position adjacent to and over top of a person's hip joints. The guards are formed from rigid material so as to transfer the force of an impact into soft tissue and muscle surrounding the person's hip joints. Community assembly alerts is configured to alert a monitoring service upon detection that a fall has occurred.

### TECHNICAL FIELD

The present invention relates to a protective device, and more particularly a hip protector.

### BACKGROUND ART

It is common for people to be injured by falls, accidents or other impacts.

The elderly are particularly susceptible to injury caused by falls. The incidence of falls amongst this age group increases due to loss of strength and stability associated with ageing. It has been estimated that over 13% of people aged over 65 years will experience a fall of some form.

Further, the consequences of a fall are particularly damaging to the elderly due to decrease in bone density and longer recovery times.

Hip fractures are a common result of impact caused by a fall. The hip is a joint between the leg and torso. It is made up of a socket in the pelvis and a ball at the end of the femur. The hip joint is substantially surrounded by a protective and functional layer of muscle and tissue. This protects the majority of the hip against the impact of a fall. However the greater trocanter is a protrusion of the femur lateral and external to the hip socket. The greater trocanter is not covered by the protective layer of muscle and tissue and therefore is often bears the full force of impact.

Due to the frequency of impact there is a large variety of protective devices to minimise damage from these incidents. A selection of the available devices are discussed below to provide some background for the present invention.

PCT Application No. 06/00997083 discloses a method and apparatus for body impact protection. In summary, the device relates to protective garments having inflatable air pockets.

Sensors are used to gather data on ballistic parameters such as acceleration, distance travelled relative acceleration, and rotation of the person wearing the garment. A rule based system is used to evaluate the collected ballistic parameters and determine if a trigger condition indicative of a fall is satisfied. Upon satisfying the trigger condition the air pockets are inflated with a gas. This allows the inflated pockets to minimise impact of the fall, and therefore decrease the incidence of injury.

However, the device disclosed in this patent is particularly complex requiring complex electronics to detect when a fall is in progress, and to subsequently inflate the air pockets. Therefore the device is expensive to manufacture.

Further the rule based system does not provide a fail safe system for detecting occurrence of a fall. This is relevant as failure to detect a fall can have significant consequences as the air pockets are not inflated and there is no protection from the resulting impact.

U.S. Pat. No. 7,386,894 discloses a tactile outer protective garment. The garment is intended to provide body armour to minimise gunshot injuries. The garment includes reinforcing panels specifically designed to absorb the impact of a high velocity, small area, projectile. The garments have panels to cover central areas of the body to protect major organs.

However, the configuration of the panels and the materials from which they are made means that the device does not mitigate impacts caused by falls. Therefore, the device does not provide any solution to people at risk of injury from a fall.

U.S. Pat. No. 5,546,609 discloses a helmet for providing an indication when a predetermined axial compressive force is incurred by a person wearing the helmet.

The invention relates to the inclusion of an impact sensor into the crown region of a standard football helmet. That helmet comprises a resilient hard outer shell and padding on the inside.

The sensor is configured to determine when an impact occurs that would compress the wearer's spine. Upon detection of a predetermined compressive force, an inflatable guard is activated to provide resistance to continued compression of the wearer's spine.

The sensor is also capable of remotely communicating with a monitoring system to record impacts exceeding a trigger.

However, the invention of this United States patent is intended only for use in relation to football and sporting helmets. The specific configuration and shape of the football helmet precludes its use in protecting other body parts.

In addition, the impact sensor is positioned over the outside of helmet, and configured such that it determines forces which would compress the wearer's spine. Again this limits the invention's applicability and efficacy in protecting against, and detecting, impacts of a fall where impact occurs at other than the wearer's head.

New Zealand Patent No. 335435 discloses a garment for protecting the body from shock in selected regions. The garment comprises a plurality of protective areas that are held in position over top of the selected body parts. The garment includes non-protective areas for providing structural integrity to the garment, and assists in holding the protective areas over the body parts.

The protective areas are specifically intended to minimise the impact caused by impact to a person's hip joint. To this end, they sit over top of the hip joint and extend from the pelvis posteriorly to the rear of the body to the lower region of the gluteus muscles. However, the protective areas are only soft padding and there is no discussion of alternatives. Therefore, those areas only dampen the force of an impact. It is still possible that the person's, hip joint will receive some impact from a fall, and therefore may still be damaged.

It should also be appreciated that the foregoing do not provide cost effective devices to protect against the impact of a fall.

Further, all of the devices currently available are bulky and cumbersome to wear. This means that people are less likely to wear those devices. Essentially, the device is unable to provide any benefit if it is not being worn. This is exemplified in a recent study by Cameron et al. that directly correlated the effectiveness of a protective garment to the adherence of use.

Therefore, it is an objective of the present invention to address the problems with the prior art. Alternatively, it is an object of the present invention to provide the public with a useful alternative.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF THE INVENTION

According to one aspect of the present invention, there is provided a protective device, including

a guard,

a securing portion configured to position the guard against a person's body so as to facilitate the guard protecting the person's hip joint against an impact,

a communication assembly,

an impact sensor configured to determine when an impact has occurred,

characterised in that

the communication assembly is configured to send a message to a monitoring service when the impact sensor determines that an impact has occurred.

According to another aspect of the present invention, there is provided a method of protecting a person's hip joint from an impact, the method including the steps of:
(a) providing a protective device including a guard, a securing portion, a communication assembly, and an impact sensor;
(b) arranging the securing portion to position the guard against the person's body so as to facilitate the guard protecting the person's hip joint against an impact;
(c) using an impact sensor to determine when an impact has occurred;
the method characterised by the step of:
(d) using the communication assembly to alert a monitoring service that an impact has occurred.

In a particularly preferred embodiment the present invention is a protective device to minimise injury to a person's hips caused by impact. Reference will be made herein accordingly.

However, the foregoing should not be seen as limiting and alternatives are envisaged: Those include use of the present invention with devices to protect against damage to other body parts from differing types of impact. For instance, the present invention could be used to protect against damage to shoulders, elbows, knees, etc.

The inventor has found the present invention necessary as there is a high incidence of falls amongst the elderly. Those falls cause injury to body parts and in particular, the person's hips. Therefore, in a preferred embodiment the present invention is a device to minimise injury to a person's hips caused by an impact resulting from a fall.

Throughout the present specification reference will be made to the terms “fall” and “impact”.

The term “fall” should be understood as meaning a loss of balance, footing, and/or stability and subsequent descent due to gravity.

The term “impact” should be understood as meaning a collision between two objects. In relation to the preferred embodiment of the present invention an impact will be between a person that falls and an object such as the ground.

Reference will be made herein accordingly.

Throughout the present specification reference to the term “guard” should be understood as meaning a component to minimise, the effect of an impact.

In a preferred embodiment, the guard acts as a barrier between a body part such as the greater trocanter and an object. This facilitates the guard minimising injury caused by an impact.

In a particularly preferred embodiment the guard ensures that an object does not touch or strike the greater trocanter. Rather, the object touches the guard, which in turn transfers the force of the impact to the tissue and muscle surrounding the person's hip joint.

In a particularly preferred embodiment, the guard is rigid such that it is not substantially deformed by an impact. For example, the guard may be formed from reinforced plastic or extruded metallic materials that provide it with sufficient strength that the guard is able to withstand, and is not substantively deformed by, the impacts it encounters in use.

The strength of the guard may be determined according to the size of impacts that it will encounter. For instance, the weight and height of the person wearing the device could determine the strength of impacts that the device may experience.

In a preferred embodiment, the body has a reuleaux triangle shape.

However this should not be seen as limiting and alternatives are envisaged for the shape of the body including equilateral triangles, circles, or squares.

In a particularly preferred embodiment the guard includes a cavity able to receive a person's greater trocanter. This is important in facilitating the guard deflecting the force of an impact away from the greater trocanter. The cavity allows the guard to sit over top of the greater trocanter without touching this bone.

Preferably the guard includes a bearing surface that abuts the muscle and/or soft tissue around the greater trocanter. This may be beneficial in transferring the force of an impact to an area surrounding the person's hip, thereby helping to minimise the damage of an impact. This aspect should become clearer from the following description.

It should be understood that reference to the term “abuts a person's body” includes embodiments where the inner surface lies against a person's clothing or underwear. Therefore, it is envisaged that the protective device could be worn over top of a person's clothing. However for ease of reference discussion herein will be made to the guard abutting a person's body.

Throughout the present specification, reference to the term “outer surface” should be understood as meaning the surface of the guard distal to the person's body. Therefore, the outer surface is on the far side of the persons' body from the bearing surface. This should become clearer from the following description.

In a particularly preferred embodiment, the outer surface provides an impact point that an object touches. That point is spaced apart from the person's body and greater trocanter. Therefore this may help to reduce injuries from a fall.

In a preferred embodiment the guard has a casing.

Throughout the present specification, reference to the term “casing” should be understood as meaning a cover for the guard.

In a particularly preferred embodiment the casing can also hold the impact sensor, communication assembly, and/or other electronics of the present invention. This may be beneficial as it provides a compact device. It may also facilitate the guard and electronics of the present invention being easily moved from between and used with a plurality of securing portions.

In a preferred embodiment, the casing may be made from water proof, impact absorbing, and/or breathable material(s). Therefore, the casing may provide further protection against the impact of a fall. In addition, the material from which the casing is made may make the guard more easily removed from the device and cleaned. These aspects of the present invention should become clearer from the following description.

In the preferred embodiment, the securing portion holds the guard adjacent to, and overtop of, a person's hip(s). This allows the guard's cavity to receive the person's greater trocanter of the hip joint:

In a preferred embodiment the securing portion includes a belt and a plurality of pockets to receive the guards. This includes a holster arrangement.

In the embodiment of a holster the pockets are configured to be moveable along the length of the belt. This allows the pockets to be more accurately aligned with a person's hips. This allows the device to be used with people of different sizes, heights and girth.

However, the foregoing should not be seen as limiting and alternatives are envisaged including those where the guards are sewn into underwear or other clothing.

In a preferred embodiment the belt may be a lifting belt.

Reference to the term “lifting belt” should be understood as meaning a belt with sufficient strength that it does not break when under strain of a person's weight. Therefore, the belt facilitates care givers and medical or emergency personal in moving a person into a recovery position after a fall occurs. This may be a particularly beneficial feature as it may assist in providing emergency care after a fall.

In particularly preferred embodiment, the lifting belt may be configured to support weights of between 45-100 kgs. This is a common range of weights of elderly people and also a range that can be easily lifted by medical staff without lifting equipment.

However, the foregoing should not be seen as limiting and alternatives are envisaged. Those include the use of non-lifting belts, or lifting belts capable of lifting weights outside of the range of 45-100 kgs.

In a particularly preferred embodiment the pockets allow changing of the guards. This may be achieved by the pockets having apertures allowing the guards to be easily inserted therethrough. In this embodiment closures mechanisms such as zips or button fasteners allow the pockets to be closed to ensure that the guards remain in the pockets.

This feature allows the guards to be changed should they malfunction. Also, the securing portion can be easily washed without damaging the electronics.

Yet a further advantage provided by this feature may be that it ensures the device is cost effective and can be worn by people at all times. For instance, a person may have multiple securing portions yet require only one set of guards. The guards can be interchanged as necessary between securing portions.

In a preferred embodiment, the pockets may facilitate a person moving between a standing position and a sitting position. For instance, when a person is sitting, the femur is substantially perpendicular to the torso. However, while standing the femur is substantially parallel to the torso. Further, while walking the femur may move through a range of angles to the torso.

Accordingly, the present invention may be configured to facilitate a person moving between sitting and walking positions, thereby improving adherence of use.

In the preferred embodiment, the pockets are able to pivot about the belt. Therefore, as a person moves between different positions the corresponding movement of the pockets is achieved.

In a particularly preferred embodiment pivoting of the pockets is achieved by having flexible attachment means. Therefore force exerted to the holster pockets causes these to move bout the belt.

In a particularly preferred embodiment, the holster pockets have a taper between the central portion of the pocket to the section at which the pocket is attached to the belt. This feature allows the holster pockets to still receive the guard. However the taper allows the pockets to pivot with respect to the belt.

Throughout the present specification reference to the term “impact sensor” should be understood as meaning a component to detect when an impact has occurred.

In a preferred embodiment, the impact sensor is configured to detect pressure applied to the outer surface of the guard.

In a preferred embodiment, the impact sensor has a trigger limit. Reference to the term “trigger limit” should be understood as meaning a minimum pressure necessary to detect that an impact has occurred. The trigger limit may be determined as a universal criteria for all wearers, or dependent on the weight or height of a person wearing the device.

In a particularly preferred embodiment the impact sensor is a plurality of membranes connected to an electrical circuit. These membranes may be laid over the outer surface of the guard. Impact causes the membranes to deform and contact thereby completing an electrical circuit to provide a signal that an impact has occurred.

In this embodiment the plurality of membranes are separated by a spacer material. The spacer material is configured such that it separates the membranes, yet allows these to deform and contact each other when an impact occurs. This completes an electrical circuit to detect an impact.

This embodiment provides a compact impact sensor that can detect impact at a variety of positions across the guard's outer surface.

The spacer material also provides padding to help minimise the impact of a fall. These aspects of the present invention should become clearer form the following description.

However, alternative embodiments are envisaged including those using other types of impact sensors.

Throughout the present specification reference to the term communication system should be understood as referring to an electronics assembly that is capable of sending messages.

The communication system is connected to the impact sensor. In this embodiment the impact sensor triggers operation of the communication system when an impact is detected.

The communication system is then able to send a signal to an emergency or monitoring service advising of the occurrence of a fall and the subsequent impact. The signal may also include GPS data, location details, or other information/identifiers that enable medical services to quickly respond to the incident.

However the foregoing should not be seen as limiting and alternatives are envisaged including different types of electronic signal sending systems; or devices that do no incorporate signal sending capability.

In a preferred embodiment the present invention may include an auditory system.

Throughout the present specification reference to the term “auditory system” should be understood as meaning a system to provide an audible message to a person wearing the device on occurrence of an impact.

The message may provide reassurance to the wearer that medical assistance is on the way, or otherwise reassure the wearer.

The auditory system may also provide a warning signal that the impact sensor has triggered the communication system.

The present invention may also include an override switch.

Throughout the present specification reference to the term “override switch” should be understood as meaning a switch that allows a wearer to override the sending of messages via the communication system. This limits the occurrence of false alarms.

However the foregoing should not be seen as limiting and use of an override is not essential to the success of the present invention.

It should be appreciated from the foregoing description that the present invention may provide a number of advantages over the prior art.

Firstly, the protective device disclosed herein could provide a cost effective way to minimise injuries caused by falls.

Secondly, the present invention may provide improved protection over the prior art protective garments because adherence of use could be improved. That is, people are more likely to wear the protective device as it is comfortable, and unobtrusive.

Thirdly, the present invention can be easily maintained with the holster being machine washable with the guard/electronics being easily removable from the device.

Fourthly, the present invention can assist in post fall procedures. For instance, the message sending system alerts medical providers to the occurrence of a fall while the lifting belt feature can facilitate emergency/medical services moving a person into a recovery position from which they can administer assistance.

It should be appreciated that the foregoing description of advantages is exemplary only. The protective device disclosed herein may have other benefits and advantages not specifically discussed that are a result of its unique combination of features and the interaction of these.

### BRIEF DESCRIPTION OF THE DRAWINGS

Further aspects of the present invention will become apparent from the ensuing description which is given by way of example only and with reference to the accompanying drawings in which:

FIG. 1 is a side perspective view of a protective device according to the present invention;

FIG. 2 is an alternate perspective view of a section of FIG. 1;

FIG. 3 is a side view of a protective device on a person;

FIG. 4 is an exploded view of the parts forming the guard adjacent to a protective device according to the present invention;

FIG. 5 is a side view of an assembled guard;

FIG. 6a is a front perspective view showing the protective device as it would be secured on a person;

FIG. 6b is an alternate side perspective view of FIG. 6A;

FIG. 6c is a back side view of a protective device on a person;

FIG. 7A is a cross-sectional view of a person's hip joint;

FIG. 7B is an exploded view of FIG. 7A;

FIG. 8A is a front perspective view of an alternate embodiment of a protective device accordingly to the present invention;

FIG. 8B is a rear perspective view of FIG. 8A;

FIG. 9A is a perspective view of a rigid body forming part of a guard according to the present invention; and

FIG. 9 B is an alternate side perspective view of FIG. 9A.

### BEST MODES FOR CARRYING OUT THE INVENTION

The present invention provides a protective device (1) in the form of a hip protector. Throughout the description like numerals refer to like components.

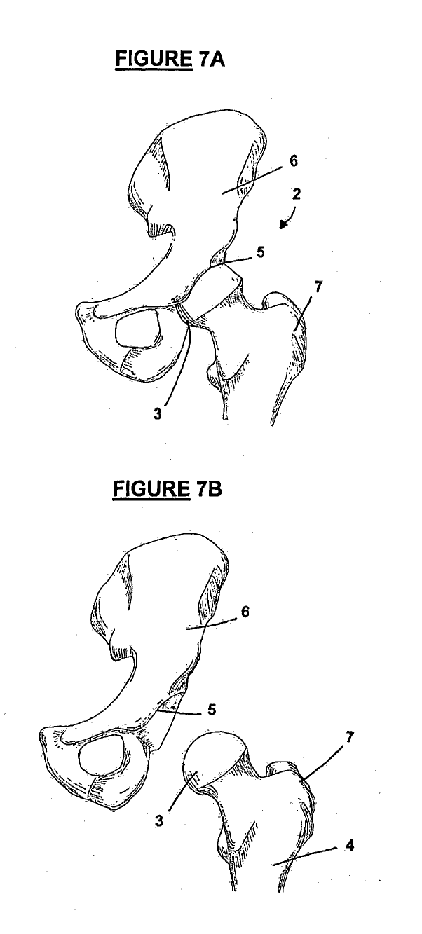

The protective device (1) is configured to protect a person's hip joint (2) against the impact of a fall. FIG. 7 shows a cross-sectional schematic of a human's hip joint, indicated generally by (2) to clarify terms used in the ensuing discussion

The hip joint (2) is a synovial joint formed by the articulation of the rounded head (3) of the femur (4) and the acetabulum (5) of the pelvis (6). The greater trocanter (7) is a protrusion at the rounded head (3) of the femur (4). The greater trocanter (7) extends laterally to the rounded head (3) and sits outside of the acetabulum (5).

The acetabulum (5) is surrounded by muscle and soft tissue (not shown), and as a result the greater trocanter (7) is often the only palpable bony structure of the hip joint (2).

This terminology is as should be understood by those skilled in the art. However, some variation can occur due to differing conventions between health practitioners, drafts people, and countries.

The aspects of the protective device (1) will now be described with reference to the components from which it is manufactured.

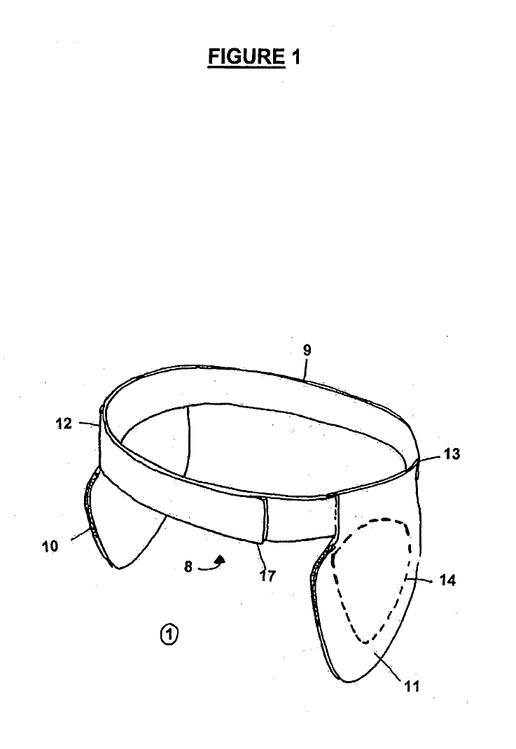

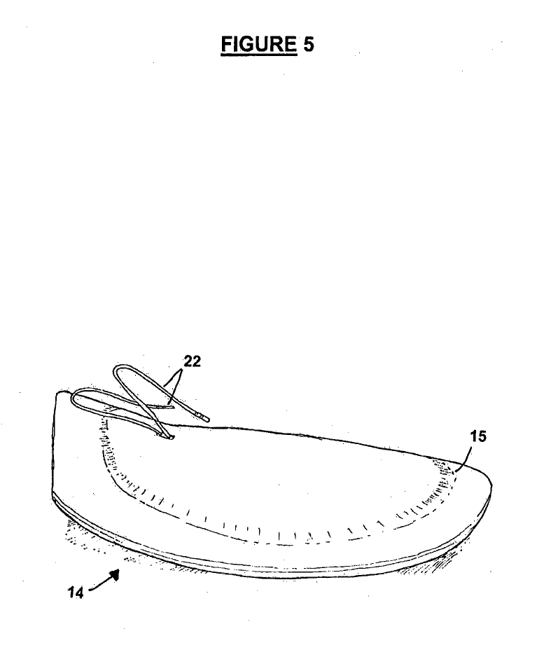

Referring now to FIGS. 1 to 6C showing a first embodiment of the protective device (1).

The protective device (1) includes a securing portion (8) formed from a belt (9) and a plurality of holster pockets (10,11). Belt (9) is made from a reinforced web material and allows it to be used to lift a wearer after a fall. That is, the belt (9) has, sufficient strength such that it does not tear or rip when it is used to lift a person. This should become clearer from the following description.

Holster pockets (10,11) are formed from felted wool cloth, which can make the device (1) more comfortable to wear. In addition the holster pockets (10,11) may provide warmth when worn, thereby helping to reduce discomfort from ailments such as arthritis. This may help to improve compliance of wearing the protective device (1).

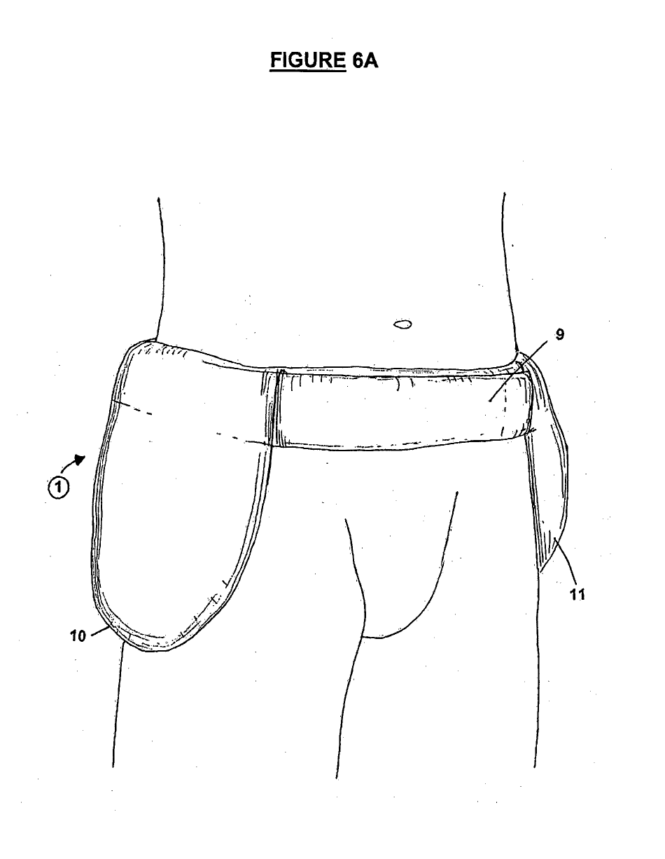

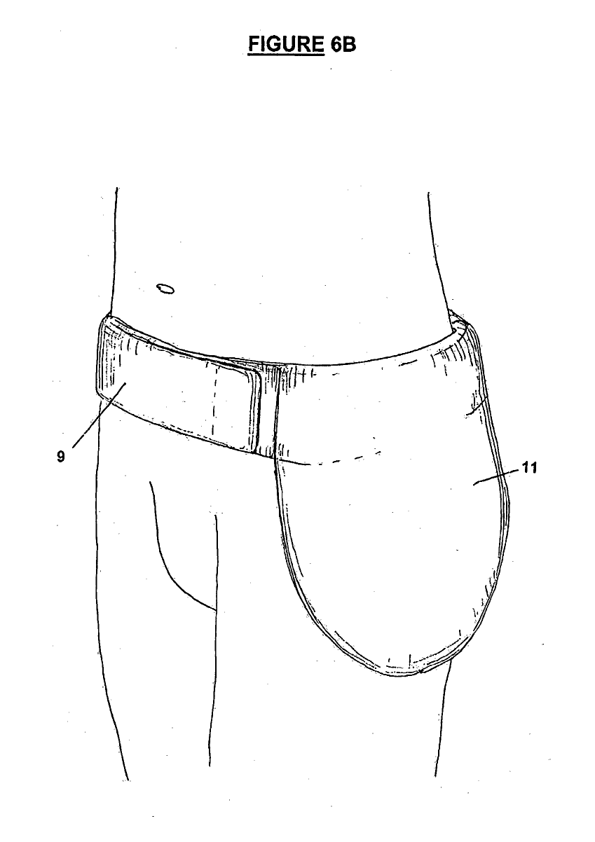

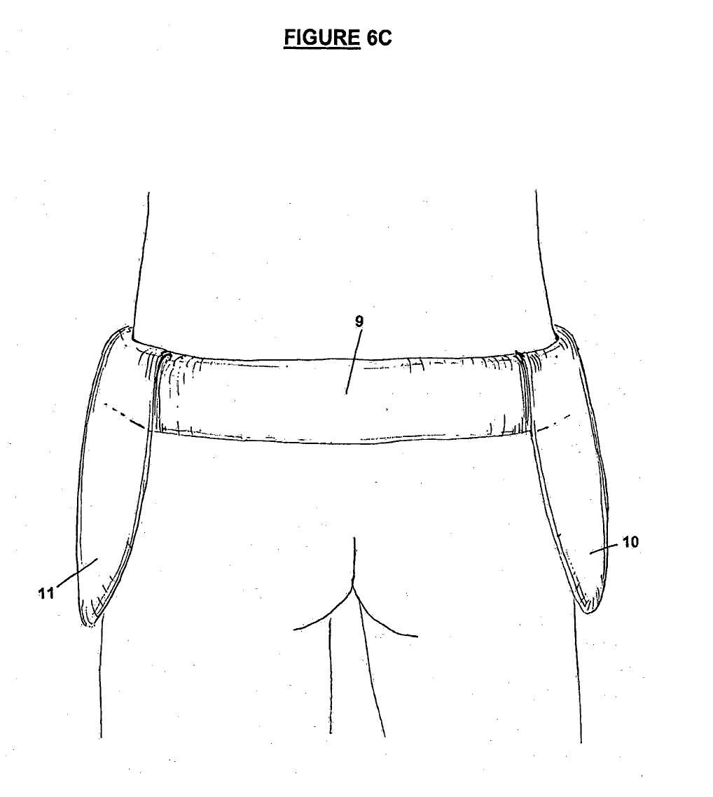

Holster pockets (10,11) have loops (12,13) through which the belt (9) can be threaded. The holster pockets (10,11) can be moved along the length of the belt (9) to align them with a hip joint (2). This position is indicated in FIGS. 3 and 6A to 6C.

Each holster pocket (10,11) is configured to releasably receive a guard (14). Therefore, the device has two guards (14).

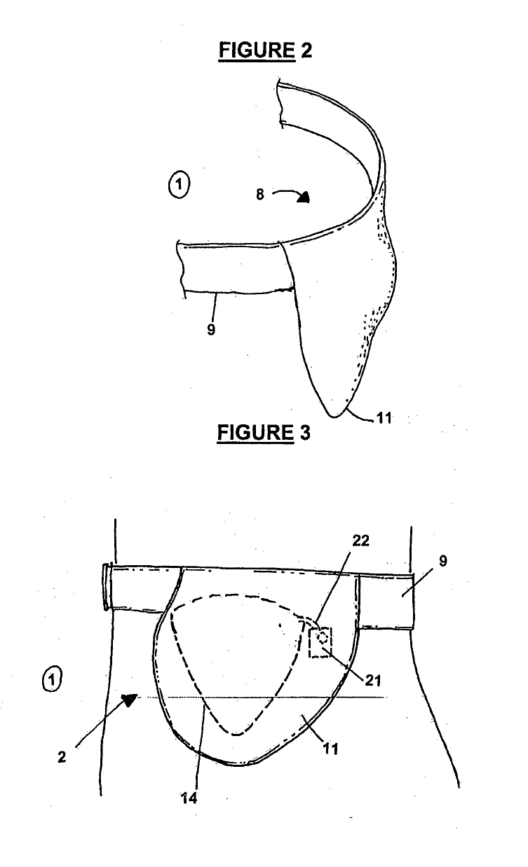

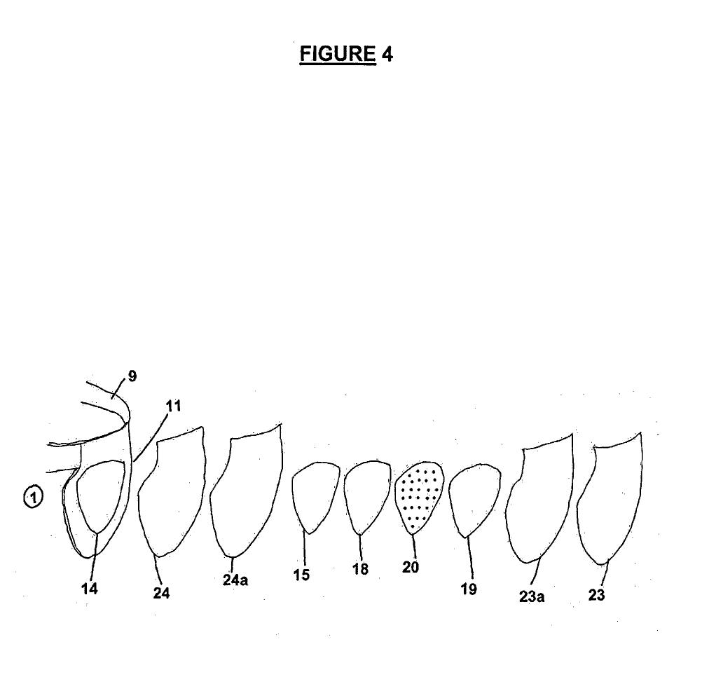

FIG. 2 shows a guard (14) according to the present invention. FIG. 4 shows an exploded view of the components forming the guard (14).

The guard (14) includes a rigid body (15) which is formed from reinforced polyethylene. The guard (14) has a realeaux triangle shape meaning that it can surround hip joint (2) without being overly bulky. The rigid body (15) has a cavity (16). The edges (17) of the cavity (16) provide a bearing surface that is configured to abut the soft tissue and muscles around a person's hip joint (2).

The cavity (16) has a size such that it can receive and not touch the person's greater trocanter (7). This is important to operation of the protective device (1) and should become clearer form the following description.

An impact sensor is formed from two aluminium foil membranes (18,19), separated by spacer (20). The spacer (20) is made from a closed cell perforated urethane sheet material. The spacer (20) has a plurality of apertures (20A). The apertures (20A) allow the aluminium membranes (18,19) to touch when the spacer (20) and membranes (18, 19) are sufficiently deformed. This completes a circuit and detects an impact. This should become clearer form the following description.

The aluminium membranes (18,19) are releasably connected to an electronic assembly (21) via cables (22). The operation of the electronic assembly (21) will be discussed in more detail below with reference to operation of the protective device (1) in use.

A casing is formed from sheets of closed cell urethane foam (23,24). The foam (22) is waterproof and assists in impact absorption to minimise the impact of a fall.

Additional impact absorbing layers (23b, 24b) can be used to assist in minimising damage from an impact. The layers (23b, 24b) are made from closed cell urethane or other material(s) having elastic properties.

The casing is shaped so as to retain the shape of cavity (16) and to ensure it is large enough to receive a person's greater trocanter (7).

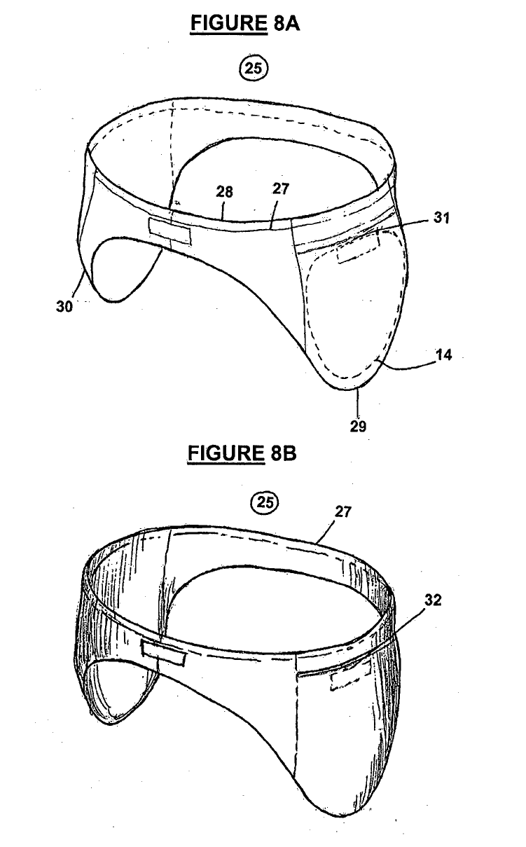

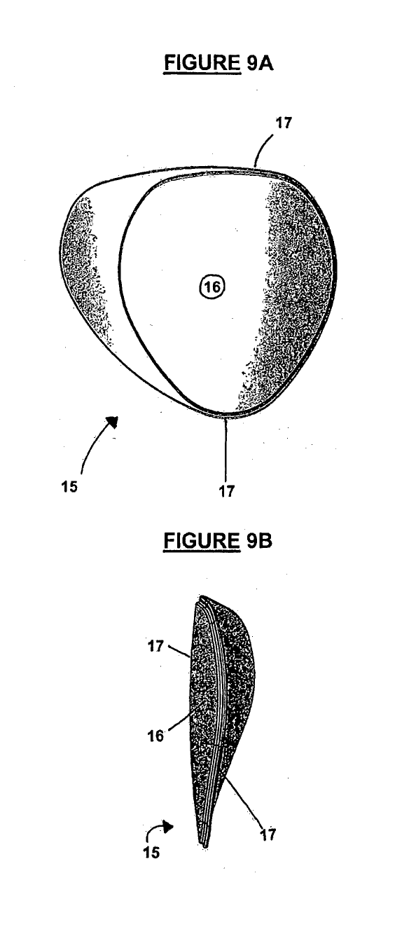

Referring now to FIGS. 8A & 8B showing an alternate embodiment of the protective device (25). A securing portion indicated as (26), is provided in the form of a garment made from cloth materials. An elastic band (27) is sewn into the top edge (28) of the securing portion (26). The elastic band (27) has a shape and configuration that allows it to be worn about a person's waist. Pockets (29,30) are integrally formed in the securing portion (26) and extend downwardly from the elastic band (27). The pockets (29,30) have openings (31,32) allowing guards (14) to be inserted therein.

The pockets (29,30) and elastic band (27) are configured so as to hold the guards (14) adjacent to, and over top of, a person's greater trocanter (7). However, the pockets and elastic band allow the person a normal range of movement. In addition, they are not so cumbersome as to be uncomfortable.

The elastic band (27) may be reinforced by webbing (not visible) so as to ensure this can function as a lifting belt.

The operation of the protective device (1) will now be discussed. The following discussion is applicable to both embodiments of the protective device (1) and (25) but reference is made only to protective device (1).

The protective device (1) is put on by a person. The holster pockets (10,11) are adjusted (if necessary) to position the guards (14) so as to sit laterally to the person's hip joints (2). This is shown in FIGS. 3 and 6a-c.

The guards (14) sit overtop of the person's greater trocanter (7) which is inside the cavity (16). The guard (14) is shown by line (33) in FIGS. 2 and 3.

If a fall occurs an object can strike the outer surface (34) of the guard (14). The impact is transferred to edges (17) of the cavity (16). The edges (17) sit against the tissue surrounding the hip joint (2). Therefore the impact of the fall is transferred to the tissue and muscles around the greater trocanter. This may help to ensure that the greater trocanter (7) is protected.

The membranes (18,19) are deformed by the impact, the spacer (20) is also deformed allowing aluminium membranes (18,19) to contact each other through apertures (20A). This completes the circuit and a signal is sent via cables (22) to the electronic assembly (21).

The electronic assembly (21) produces an audible signal indicating that the impact sensor has detected an impact. The person has the option of pressing over ride button (33) to deactivate the device if it is a false alarm.

After 30 Seconds the electronic system (21) sends a signal to a monitoring system (not shown) via a wireless communication network. The communication network may be a cell phone system or a wireless system connecting to a terrestrial communication network.

The signal includes information on the location of the fall and the person wearing the device.

The monitoring service alerts medical services to the fall and provides location and person identifier information. Emergency medical services, can respond and attend to the injured person.

The belt (9) has sufficient strength that the medical professionals can use this to lift the person and manoeuvre them into a position from which to attend to.

Aspects of the present invention have been described by way of example only and it should be appreciated that modifications and additions may be made thereto without departing from the scope thereof as defined in the appended claims.

1-20. (canceled)

21. A protective device, including
a guard formed from a rigid body,
a securing portion configured to position the guard against a person's body so as to facilitate the guard protecting the person's hip joint against an impact,
an impact sensor to determine when an impact has occurred, and
a communication assembly,
characterised in that
the communication assembly is configured to alert a monitoring service when the impact sensor detects that a fall has occurred.

22. The protective device as claimed in 21, wherein the guard includes a recess in an inner surface to receive the greater trocanter of the person's hip joint.

23. The protective device as claimed in claim 21, wherein the guard is configured to transfer the force of an impact into soft tissue surrounding the person's hip joint.

24. The protective device as claimed in claim 23, wherein the guard includes a bearing surface that sits against the soft tissue around the person's hip joint so as to transfer the force of an impact to the soft tissue.

25. The protective device as claimed in claim 21, wherein the securing portion is a holster formed from a belt and a plurality of pockets.

26. The device as claimed in claim 25, wherein the pockets are movable along the belt's length.

27. The protective device as claimed in claim 25, wherein the belt is a lifting belt to facilitate lifting of the person after an impact occurs.

28. The protective device as claimed in claim 21, wherein the impact sensor includes a plurality of membranes secured to the outside surface of the guard.

29. The protective device as claimed in claim 28, wherein the plurality of membranes are separated by a porous material that allows the membranes to deform when an impact occurs so that the membranes contact each other to complete an electrical circuit and thereby detect that an impact has occurred.

30. The protective device as claimed in claim 21, wherein the guard and sensor are removable from the pocket.

31. The protective device as claimed in claim 21, wherein the guard and impact sensor are within a casing.

32. A method of protecting a person's hip joints from an impact, the method including the steps of:
(a) providing a protective garment including a guard made from a rigid body, a securing portion, an impact sensor, and a communication assembly;
(b) arranging the securing portion so as to position the guard against the person's body to facilitate the guard protecting the person's hip joint against the impact;
(c) using the impact sensor to determine when an impact has occurred;
the method characterised by the step of:
(d) using the communication assembly to alert a monitoring service when the impact sensor detects that a fall has occurred.

33. A component of a protective device for reducing injury to a person's hip joint caused by an injury, the component including
a guard made from a rigid body,
wherein the guard is configured to be held adjacent to the person's hip joint,
an impact sensor, and
a communication assembly
characterised in that
the communication assembly is configured to alert a monitoring service when the impact sensor detects that an impact has occurred.

34. The component as claimed in claim 33, wherein the inner surface has a recess to receive the greater trocanter of the person's hip joint.

35. The component as claimed in claim 33, wherein the impact sensor is formed from a plurality of membranes secured to the outside surface of the guard.

36. The component as claimed in claim 35, wherein the plurality of membranes are separated by a porous material to allow the membranes to deform when an impact occurs so that the membranes contact each other to thereby detect that an impact has occurred.

37. The component as claimed in claim 33, wherein the guard and impact sensor are within a casing.
